(19) United States
(12) Patent Application Publication
(10) Pub. No.: US 2006/0015658 A1
(43) Pub. Date: Jan. 19, 2006

(54) Multimedia processing system

(75) Inventors: Kazuyuki Uchida, Osaka (JP); Toshio Higuchi, Kyoto (JP); Takashi Sakai, Kyoto (JP); Akihiro Miyazaki, Osaka (JP); Michiko Matsumoto, Osaka (JP); Kuniaki Sugimoto, Hiroshima (JP)

Correspondence Address: MCDERMOTT WILL & EMERY LLP, 600 13TH STREET, N.W., WASHINGTON, DC, 20005-3096, US

(73) Assignee: MATSUSHITA ELECTRIC INDUSTRIAL CO., LTD

(21) Appl. No.: 11/177,572

(22) Filed: Jul. 11, 2005

(30) Foreign Application Priority Data
Jul. 14, 2004 (JP) P2004-207453

(51) Int. Cl. G06F 13/12

(52) U.S. Cl. 710/10; 710/68

(57) ABSTRACT

A multimedia processing system of the present invention comprises an application, a multimedia abstracting unit, and a multimedia processing module. The multimedia processing abstracting unit is comprised of: a logic module; a stream path for connecting each logic module; a stream pipe for transmitting/receiving data between each logic module and the application; and a correspondence managing unit which carries structural information of the logic module, the stream pipe, and the stream path for making correspondence between with the processing module. The correspondence managing unit updates the structural information every time each logic module is created and connected according to the command from the application and, thereafter, at the point where the stream pipe and stream path are connected, receives a LOCK command indicating confirmation of structure from the application. Thereby one corresponding processing module is confirmed and started.

### FIELD OF THE INVENTION

The present invention relates to a multimedia processing system which performs processing of multimedia data such as audio (sound), video (image), text, still picture, etc, which are being digital-compressed. For example, it can be utilized in the case where software for television sets, videos, DVDs, portable devices and the like is used by being abstracted into processing modules.

### BACKGROUND OF THE INVENTION

Recently, due to well-equipped information infrastructure and developments in multimedia technology, such multimedia apparatuses have been manufactured, which enable to record and reproduce multimedia streams of various codec systems (data compression/decompression system) from various transmission paths and media. For example, there has been introduced such a product which can perform a plurality of types of processing such as reproduction/recording of MPEG (Moving Picture Experts Group), reproduction/recording of audio, reproduction/recording of still pictures, etc, by a single apparatus.

As a method for performing various codec system multimedia processing by such apparatus, there is proposed a system which processes a series of multimedia processing into logic modulations of small processing units and changes connection of those logic modules for changing the processing to be performed (for example, Japanese Patent Unexamined Publication No. 10-283195). In this system, the logic module of the processing unit corresponds on one-on-one basis to the processing module for performing the actual processing, e.g., the logic module of the processing unit is a driver of specific hardware or a software filter, etc.

However, when there is a single processing module having functions of a plurality of logic modules in a conventional system, it is not possible to determine when the connection to the logic module ends. Thus, there is a problem that an appropriate processing module cannot be started. For example, if the conventional system has an audio reproduction processing module having two functions of audio decoder and audio output as the logic module and, similarly, has audio-video (AV) reproduction processing module having four functions of audio decoder, audio output, video decoder, and video output as the logic module, from the point where the logic module of audio decoder and the audio output is created and connected, it becomes impossible to determine whether or not there is creation and connection of the processing module of the video decoder and the video output performed thereafter. Thus, it cannot determine whether to start the audio reproduction processing module or to wait for creation and connection of the logic module of the video decoder and video output.

### SUMMARY OF THE INVENTION

Therefore, the main object of the present invention is to provide a multimedia processing system which can start an appropriate processing module even in a system wherein a logic module in which multimedia processing is abstracted and a multimedia processing module for performing actual processing are not in correspondence on one-on-one basis.

In order to achieve the foregoing object, the present invention has been designed as follows.

A multimedia processing system according to claim 1 of the present invention comprises
an application for giving a command to create and connect a logic module and for informing structure confirmation of the logic module,
a multimedia processing abstracting unit which works according to the command from the application, and
a processing module for performing actual multimedia processing, wherein
the multimedia processing abstracting unit is comprised of:
a logic module for abstracting each function for the multimedia processing;
a stream path for connecting each logic modules;
a stream pipe for transmitting/receiving data between each logic module and the application; and
a correspondence managing unit which has structural information of the logic module, the stream pipe, and the stream path for making correspondence with the processing module, wherein
the correspondence managing unit updates the structural information every time each logic module is created and connected according to the command from the application and, thereafter, at a point where the stream pipe and stream path are connected, confirms and starts one corresponding processing module by receiving a LOCK command indicating confirmation of structure from the application (see FIG. 1, FIG. 2, FIG. 3).

In the case of the present invention as claimed in claim 1, it is possible to start an appropriate processing module even in a system in which the logic module obtained by abstracting the multimedia processing and the multimedia processing module for actually performing the processing are not in correspondence on one-on-one basis.

The multimedia processing system according to claim 2 of the present invention is the multimedia processing system of claim 1, wherein:
in an arbitrary logic module, the multimedia processing abstracting unit receives the LOCK command indicating confirmation of structure of the logic module from the application at a point where connection of the stream pipe and the stream path is completed, and confirms and starts a corresponding processing module at a point where all logic modules reachable from the logic module through the stream path have received the LOCK command (see FIG. 4).

In the case of the present invention as claimed in claim 2, even in the case where a plurality of tasks (processes) perform creation and connection of the logic module, it is possible to start an appropriate processing module by simply informing structure confirmation of the logic module created by the task itself without minding the structure confirmation of other tasks (processes).

The multimedia processing system according to claim 3 of the present invention is the multimedia processing system of claim 1, wherein: for forming said processing module by creating and connecting the logic module from a plurality of application tasks (processes), information indicating which of the application tasks gives the lock command to the logic module is held in a table in advance for checking which of the application tasks has called the LOCK command when there is the LOCK command from the application; and when there is no corresponding processing module at a point where all LOCKs from a single application task are completed, the application task is switched so that following processing is not performed until a corresponding processing module is started (see FIG. 5).

In the case of the present invention as claimed in claim 3, even in the case where a plurality of application tasks (processes) perform creation and connection of the logic module, the application task is automatically switched to another application task after confirmation of the own structure. Thus, it is possible to execute the following command after starting an appropriate processing module without performing communication with other application tasks.

The multimedia processing system according to claim 4 of the present invention is the multimedia processing system of claim 1, comprising:
a processor environmental information obtaining means which holds processing module action environmental information such as CPU use amount and memory use amount to be consumed when operating each processing module and obtains processor environmental information such as current CPU use amount and memory use amount of a processor operated by the processing module; and a processing module judging means which judges and starts an optimum multimedia processing module by comparing the processor environmental information obtained by the processor environmental information obtaining means and the processing module action environmental information (see FIG. 6).

In the case of the present invention as claimed in claim 4, the optimum processing module can be started when there are a plurality of processing modules which correspond to the structure.

The multimedia processing system according to claim 5 of the present invention is the multimedia processing system of claim 1, wherein
at the time of performing matching under a LOCK state, when there are processing modules capable of same processing in a combination of two or more processing modules, convergence capacities of a plurality of said processing modules are investigated, respectively, to be started (see FIG. 7).

In the case of the present invention as claimed in claim 5, when the desired processing can be achieved by a combination of two processing modules, those processing modules can be started and executed.

The multimedia processing system according to claim 6 of the present invention is the multimedia processing system of claim 1, wherein
at the time of performing matching under a LOCK state, when there is a processing module which is partially in match, the module is started for performing only necessary processing (see FIG. 8).

In the case of the present invention as claimed in claim 6, when the desired processing can be achieved by a part of a single processing module, the processing module can be started and executed.

The multimedia processing system according to claim 7 of the present invention is the multimedia processing system of claim 1, wherein
at the time of performing matching under a LOCK state, when there is unnecessary connection, matching of corresponding processing module is performed after optimizing the connection (see FIG. 9).

In the case of the present invention as claimed in claim 7, even when there is an unnecessary connection of the logic module, it is possible to start the corresponding processing module by optimizing it.

The multimedia processing system according to claim 8 of the present invention is the multimedia processing system of claim 1, comprising a stream-corresponding logic module structure table which shows logic module structures necessary for processing each stream, wherein
by giving only codec information of a stream to be flown, a corresponding structure is created based on the stream-corresponding logic module structure table for judging and starting a processing module which can perform processing (see FIG. 10).

In the case of the present invention as claimed in claim 8, it is possible to confirm the structure of the logic module and start an appropriate processing module by giving only the stream information.

The multimedia processing system according to claim 9 of the present invention is the multimedia processing system of claim 1, comprising a stream analyzing means for analyzing an actually written stream, wherein
through analyzing the actually written stream using the stream analyzing means by simply writing a stream, a corresponding structure for the written stream is automatically created for judging and starting a processing module which can perform processing (see FIG. 11).

In the case of the present invention as claimed in claim 9, it is possible to confirm the structure of the logic module and start an appropriate processing module by actually writing the stream.

The multimedia processing system according to claim 10 of the present invention is the multimedia processing system of claim 1, wherein
at the time of performing matching under a LOCK state, when there is no corresponding processing module in the system, a download server is checked and when there is a corresponding processing module found therein, the corresponding processing module is downloaded and executed (see FIG. 12).

In the case of the present invention as claimed in claim 10, even when there is no corresponding processing module in the multimedia processing system, one can be downloaded from the download server and executed.

The multimedia processing system according to claim 11 of the present invention is the multimedia processing system of claim 1, wherein
at the time of performing matching under a LOCK state, even when there is a corresponding processing module in the system, a download server is checked, and when there is another corresponding processing module found therein and it is judged that another module is in a better condition than said existing module by comparing them to CPU use amount and memory use amount and the like, another corresponding processing module is downloaded and executed (see FIG. 13).

In the case of the present invention as claimed in claim 11, even when there is a corresponding processing module in the multimedia processing system, it is possible to execute the still better optimum processing module by checking the download server.

The multimedia processing system according to claim 12 of the present invention is the multimedia processing system of claim 8, wherein
when there is no corresponding processing module, the codec information is transmitted to a download server and the corresponding structure is checked within the download server for downloading a processing module and a structure table (see FIG. 14).

In the case of the present invention as claimed in claim 12, even when there is no corresponding processing module in the multimedia processing system, it is possible to download the corresponding processing module from the download server by giving only the codec information.

The multimedia processing system according to claim 13 of the present invention is the multimedia processing system of claim 1, wherein
in a case where a new processing module and a processing module structure managing table are added to a download server, the new processing module can be added by downloading the processing module and structural information (see FIG. 15).

In the case of the present invention as claimed in claim 15, when a new processing module and processing module structure managing table are added to the download server, it can be executed in the multimedia processing system faster through automatic download compared to the case where it is downloaded at the time of structure confirmation.

The multimedia processing system according to claim 14 of the present invention is the multimedia processing system of claim 1, wherein
in a case where a new processing module is added to a download server, a processing module structure managing table is created and downloaded by executing a structure checking unit which checks structure of the processing module within the download server (see FIG. 16).

In the case of the present invention as claimed in claim 14, when a new processing module is added to the download server, a processing module structure managing table can be automatically formed without having it registered.

The multimedia processing system according to claim 15 of the present invention is the multimedia processing system of claim 1, comprising a processing module searching means for searching which processing module is a target of transmitting a command and transmitting the command thereto when the command is transmitted to each logic module after starting the corresponding processing module (see FIG. 17).

In the case of the present invention as claimed in claim 15, when there is a command for the logic module after starting the corresponding processing module, it is possible to transmit the command to an appropriate processing module.

The multimedia processing system according to claim 16 of the present invention is the multimedia processing system of claim 15, comprising a transmission timing judging means which judges an appropriate timing for transmission and performs transmission based on processing module information being held or by inquiring to a processing module after searching the corresponding processing module by the processing module searching means when the command is transmitted to each logic module after starting the corresponding processing module (see FIG. 18).

In the case of the present invention as claimed in claim 16, when there is a command to the logic module after starting the corresponding processing module, it is possible to transmit the command to an appropriate processing module at an appropriate timing.

The multimedia processing system according to claim 17 of the present invention is the multimedia processing system of claim 1, comprising an event allotting means for judging based on structural information which logic module an event is directed to when there is the event up from the corresponding processing module after starting said corresponding module (see FIG. 19).

In the case of the present invention as claimed in claim 17, when there is an event up from a processing module after starting the corresponding processing module, the event can be allotted to an appropriate logic module.

### BRIEF DESCRIPTION OF THE DRAWINGS

The present invention is illustrated be way of example and not limitation in the figures of the accompanying drawings, in which like references indicate similar elements and in which:

FIG. 1 is a block diagram of a multimedia processing system according to a first preferred embodiment of the present invention;

FIG. 2 illustrates the order of the structure confirmation from an application in the system of the first embodiment;

FIG. 3 is an illustration for showing the structure of correspondence managing unit in the system of the first preferred embodiment;

FIG. 4 is a block diagram of a multimedia processing system according to a second preferred embodiment of the present invention;

FIG. 5 is a block diagram of a multimedia processing system according to a third preferred embodiment of the present invention;

FIG. 6 is a block diagram of a multimedia processing system according to a fourth preferred embodiment of the present invention;

FIG. 7 is a block diagram of a multimedia processing system according to a fifth preferred embodiment of the present invention;

FIG. 8 is a block diagram of a multimedia processing system according to a sixth preferred embodiment of the present invention;

FIG. 9 is a block diagram of a multimedia processing system according to a seventh preferred embodiment of the present invention;

FIG. 10 is a block diagram of a multimedia processing system according to an eighth preferred embodiment of the present invention;

FIG. 11 is an operational flow chart of a stream analyzer of a multimedia processing system according to a ninth embodiment of the present invention;

FIG. 12 is a block diagram of a multimedia processing system according to a tenth preferred embodiment of the present invention;

FIG. 13 is a block diagram of a multimedia processing system according to an eleventh preferred embodiment of the present invention;

FIG. 14 is a block diagram of a multimedia processing system according to a twelfth preferred embodiment of the present invention;

FIG. 15 is a block diagram of a multimedia processing system according to a thirteenth preferred embodiment of the present invention;

FIG. 16 is a block diagram of a multimedia processing system according to a fourteenth preferred embodiment of the present invention;

FIG. 17 is a block diagram of a multimedia processing system according to a fifteenth preferred embodiment of the present invention;

FIG. 18 is a block diagram of a multimedia processing system according to a sixteenth preferred embodiment of the present invention;

FIG. 19 is a block diagram of a multimedia processing system according to a seventeenth preferred embodiment of the present invention;

FIG. 20 is an illustration of the external appearance of an apparatus to which the multimedia processing system of the present invention is applied; and

FIG. 21 is a block diagram of the internal structure of the apparatus shown in FIG. 20.

### DETAILED DESCRIPTION OF THE INVENTION

Preferred embodiments of the present invention will be described hereinafter by referring to the accompanying drawings.

### First Preferred Embodiment

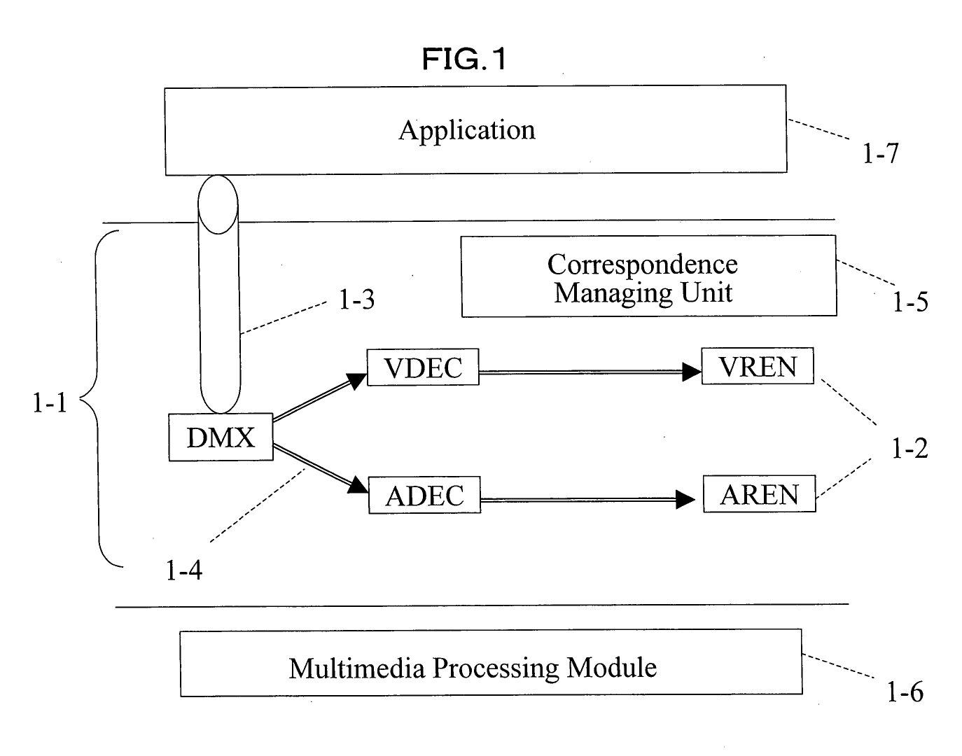

By referring to FIG. 1-FIG. 3, a multimedia processing system according to a first preferred embodiment of the present invention will be described.

FIG. 1 is a block diagram for showing the structure of the multimedia processing system. The multimedia processing system according to this embodiment is comprised of an application (1-7), a multimedia processing abstracting unit (1-1) for abstracting the processing of multimedia, and a multimedia processing module (1-6) for actually performing the processing of multimedia.

The multimedia abstracting unit (1-1) comprises: each logic module (1-2) such as DMX, VDEC, VREN, ADEC, AREN, etc., in which each function of the multimedia processing is abstracted; a stream path (1-4) for abstractly connecting each logic module (1-2), which shows flow of data between each logic module (1-2); a stream pipe (1-3) which transmits/receives data between each logic module (1-2) and the application (1-7); and a correspondence managing unit (1-5) which has structural information of the logic module (1-2), the stream pipe (1-3), and the stream path (1-4), and performs correspondence between the multimedia processing abstracting unit (1-1) and the multimedia processing module (1-6).

The correspondence managing unit (1-5) updates the correspondence structural information every time each logic module (1-2) is created and connected. Thereafter, at the point where the stream pipe (1-3) and the stream path (1-4) are disconnected, a LOCK command indicating confirmation of the structure is transmitted from the application (1-7). Thereby a single corresponding processing module is determined and started.

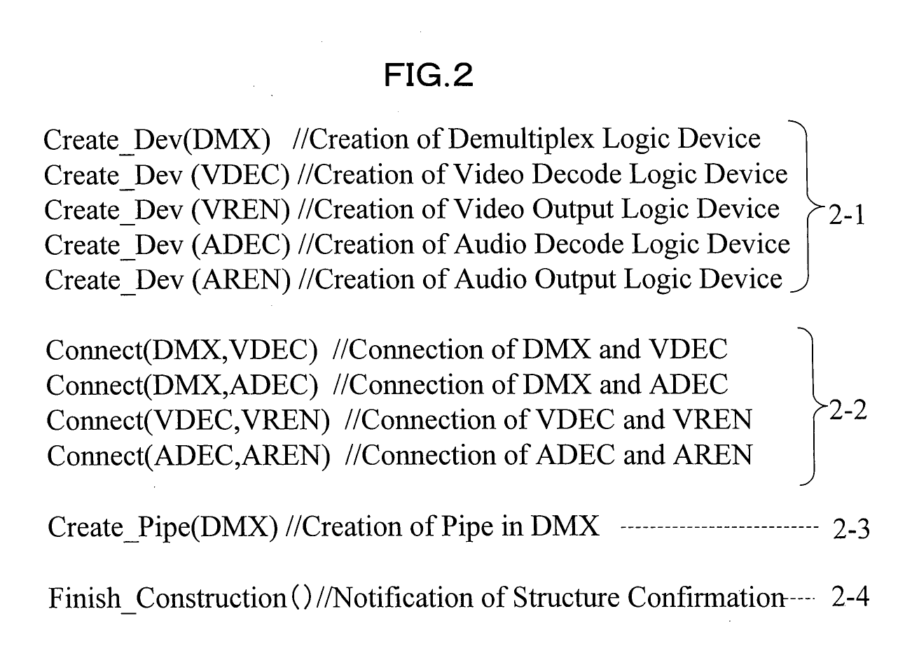

By referring to FIG. 2, described is the order of structure confirmation from the application (1-7) of this multimedia processing system. In 2-1, each logic module (1-2) is created and each logic module (1-2) is connected through the stream path (1-4) in 2-2. Every time the creation and connection is performed, the correspondence managing unit (1-5) updates the structural information managed in a logic module managing table (3-1) which will be described later.

In 2-3, the stream pipe (1-3), which transmits the stream from the application (1-7) to the logic module (1-2), is created.

In 2-4, the LOCK command which is a notification indicating confirmation of the processing structure is transmitted from the application (1-7) to the multimedia processing abstracting unit (1-1). The correspondence managing unit (1-5) of the multimedia processing abstracting unit (1-1) determines and starts a single corresponding processing module (1-6) upon receiving the LOCK command from the application (1-7).

In creation (2-1) of the logic module (1-2), Create_Dev (DMX) is creation of demultiplex logic module (DMX), Create_Dev (VDEC) is creation of video decode logic module (VDEC), Create_Dev (VREN) is creation of video render output logic module (VREN), Create_Dev (ADEC) is creation of audio decode logic module (ADEC), and Create_Dev (AREN) is creation of audio render output logic module (AREN).

In connection (2-2) of the stream path (1-4) to the logic module (1-2), Connect (DMX, VDEC) is the connection between DMX and VDEC, Connect (DMX, ADEC) is the connection between DMX and ADEC, Connect (VDEC, VREN) is the connection between VDEC and VREN, and Connect (ADEC, AREN) is the connection between VDEC and AREN.

In creation (2-3) of the stream pipe (1-3), Create_pipe (DMX) is creation of the stream pipe (1-3) in DMX. Further, Finish_Construction is to inform the confirmation of the structure.

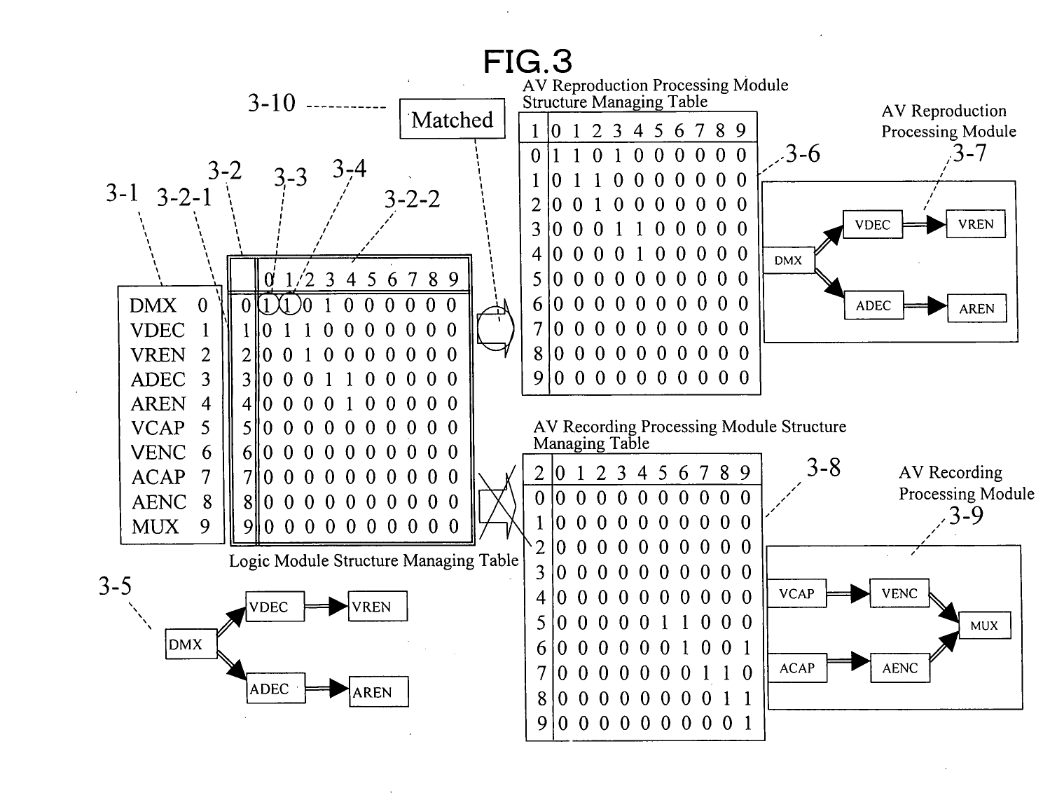

FIG. 3 shows the structure of the correspondence managing unit (1-5) of FIG. 1. Reference numeral 3-1 is a logic module ID (identification data) managing table which manages the ID of each logic module. 3-2 is a logic module structure managing table corresponding to the current structure. FIG. 3 shows the contents of connection structure 3-5 of the current logic module as an example. The connection structure 3-5 corresponds to the connection structure of the logic module (1-2) of FIG. 1. Respective logic module ID is given to each logic module (1-2).

The vertical axis (3-2-1) of the logic module structure managing table (3-2) represents the logic module ID of a connection source of the stream path (1-4), and the horizontal axis (3-2-2) of the logic module structure managing table (3-2) represents the logic module ID of the connection target. The point where the connection source ID and the connection target ID are both “n” represents the presence of the logic module (ID=N). The logic module structure managing table (3-2) is formed by creating the logic module N (=0-9) and inserting “1” into the connection source N (=0-9) and the connection target N (=0-9).

In the case of FIG. 3, in the logic module structure (3-5), the connection source and the connection target are set as DMX (ID=0) by corresponding to the presence of DMX (ID=0) of the current structure. Then, “1” is substituted to the cross point (3-3) between “0” of the vertical axis (3-2-1) and “0” of the horizontal axis (3-2-2) for indicating abstractive presence of DMX. The connection source is set as DMX (ID=0) and the connection target as VDEC (ID=1) and, as the abstractive presence of the stream path (1-4) for connecting those, “1” is substituted to the cross point (3-4) between “0” of the vertical axis (3-2-1) and “1” of the horizontal axis (3-2-2) for indicating abstractive presence of the stream path (1-4). The connection source is set as VDEC (ID=1) and the connection target as VDEC (ID=1), “1” is substituted to the cross point between “1” of the vertical axis (3-2-1) and “1” of the horizontal axis (3-2-2) for indicating abstractive presence of VDEC. The connection source is set as VDEC (ID=1) and the connection target as VREN (ID=2) and, as the abstractive presence of the stream path (1-4) for connecting those, “1” is substituted to the cross point between “1” of the vertical axis (3-2-1) and “2” of the horizontal axis (3-2-2) for indicating abstractive presence of the stream path (1-4). The same processing is continued hereinafter but the description thereof will be omitted. In the manner as described above, the logic module structure managing table (3-2) is formed in the correspondence managing unit (1-5).

The correspondence managing unit (1-5) carries processing module structure managing tables (3-6, 3-8′) by respectively corresponding to each processing module to be started. When there is a LOCK command for indicating confirmation of the structure transmitted from the application (1-7), the logic module structure managing table (3-2) which is formed and held in the manner as described above and the processing module structure managing tables (3-6, 3-8) are compared and a matched one (3-10) is started. In this example, the logic module structure managing table (3-2) matches with the AV reproduction processing module structure managing table (3-6). The logic module structure managing table (3-2) does not match with the AV recording processing module structure managing table (3-8). Reference numeral 3-7 shows the structure of the AV reproduction processing module of the AV reproduction processing module structure managing table (3-6) and 3-9 shows the structure of the AV recording processing module of the AV recording processing module structure managing table (3-8).

In the embodiment shown in FIG. 1-FIG. 3, it is possible to start an appropriate processing module even in a system where the logic module (1-2) in which the multimedia processing is abstracted and the multimedia processing module (1-6) for actually performing the processing are not in correspondence on one-on-one basis.

### Second Preferred Embodiment

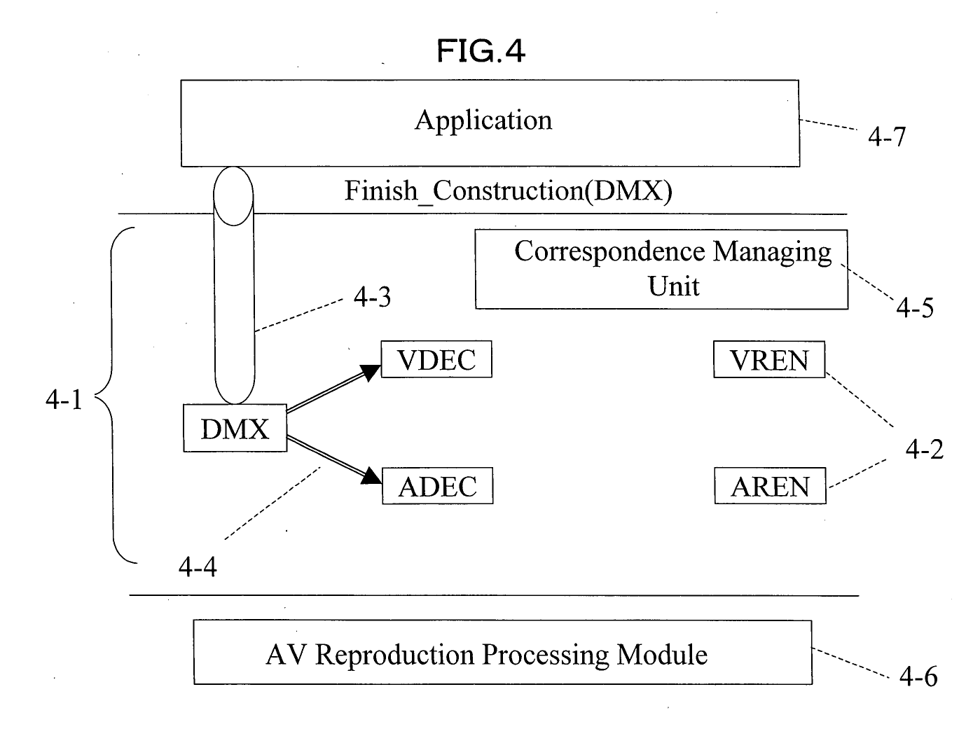

By referring to FIG. 4, the multimedia processing system according to a second embodiment of the present invention will be described.

In this embodiment, in a multimedia processing abstracting unit (4-1), at the point where connections of a stream pipe (4-3) and a stream path (4-4) to DMX are completed, respectively, in an arbitrary logic module (4-2) (in this case, DMX), DMX as the logic module (4-2) receives a LOCK command indicating confirmation of the structure from an application (4-7). If all the logic modules (in this case, VDEC, ADEC) which are reachable from DMX through the stream path (4-4) have received the LOCK command at this point, a corresponding processing module (4-6) (in this case, the AV reproduction processing module) is determined and started.

Specifically, when starting the same AV reproduction processing module as that of FIG. 1, the stream pipe (4-2) and the stream path (4-4) are connected to the arbitrary logic module (4-2) and, thereafter, at the point where it becomes unnecessary to connect the stream pipe (4-2) and the stream path (4-4) to the logic module (4-2), a command for indicating the structure confirmation of the logic module (4-2) is transmitted.

In the case of FIG. 4, since connection of DMX to the stream pipe (4-3) and the stream path (4-4) has ended, a command indicating the structure confirmation is transmitted form the application (4-7) to DMX which is the logic module (4-2) of the multimedia processing abstracting unit (4-1). At this point, the correspondence managing unit (4-5) checks through the logic module structure managing table whether or not the structure confirmation is transmitted to each of VDEC, ADEC as the logic module (4-2) which can be reachable from DMX. If the structure confirmation has been transmitted to all of the above-described DMX, VDEC, ADEC, matching is performed between the structure of the processing module constituted of these DMX, VDEC, ADEC and the structure of the processing module managed in the processing module structure managing table. Thereby, the AV reproduction processing module which is the corresponding processing module (4-6) is started.

By informing the structure confirmation as described above at the point where the structure of each logic module is confirmed, it is possible to inform the structure confirmation after creating the own logic module and completing the connection in the case where the application is divided into a plurality of modules and the logic modules to be used are different. Therefore, there requires no communication between the modules of the application for verifying whether or not it is alright to confirm the structure. Thus, the applications can be effectively developed.

### Third Preferred Embodiment

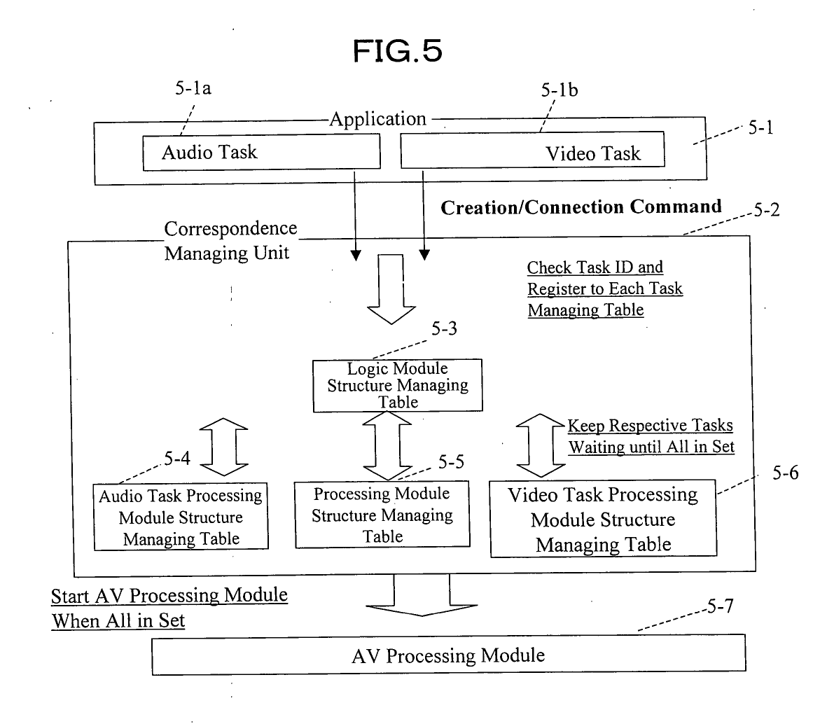

By referring to FIG. 5, the multimedia processing system according to a third preferred embodiment of the present invention will be described.

In the multimedia processing system of this embodiment, a plurality of application tasks (processes) such as Audio task (5-1a), Video task (5-1b), etc., which constitute an application (5-1) create the logic modules. By connecting each of the created logic modules, an AV processing module (5-7) for actually performing the multimedia processing is created.

FIG. 5 shows the application (5-1), a correspondence managing unit (5-2) of the multimedia processing abstracting unit, and an AV processing module (5-7) as the multimedia processing module. There are a logic module structure managing table (5-3), a processing module structure managing table (5-5), and an Audio task processing module structure managing table (5-4), a Video task processing module structure managing table (5-6) present in the correspondence managing unit (5-2).

In this embodiment, information indicating which of the tasks the logic module is created and connected from is provided in advance to respective processing module structure managing tables (5-4, 5-6) for each task. When there is a command for creating and connecting the logic module from the application (5-1), the logic module structure managing table (5-3) is updated. In the case where the structure of the processing module structure managing table (5-4 or 5-6) of an arbitrary task is completely contained in the logic module structure managing table (5-3), it is compared with the processing module structure managing table (5-5). As a result of the comparison, when matched, the corresponding AV processing module (5-7) is started. If not, the task is held standby and another task performs creation and connection of the logic device in the meantime. Thereby, each task needs to perform only the processing of processing module used by itself without synchronizing with other tasks.

### Fourth Preferred Embodiment

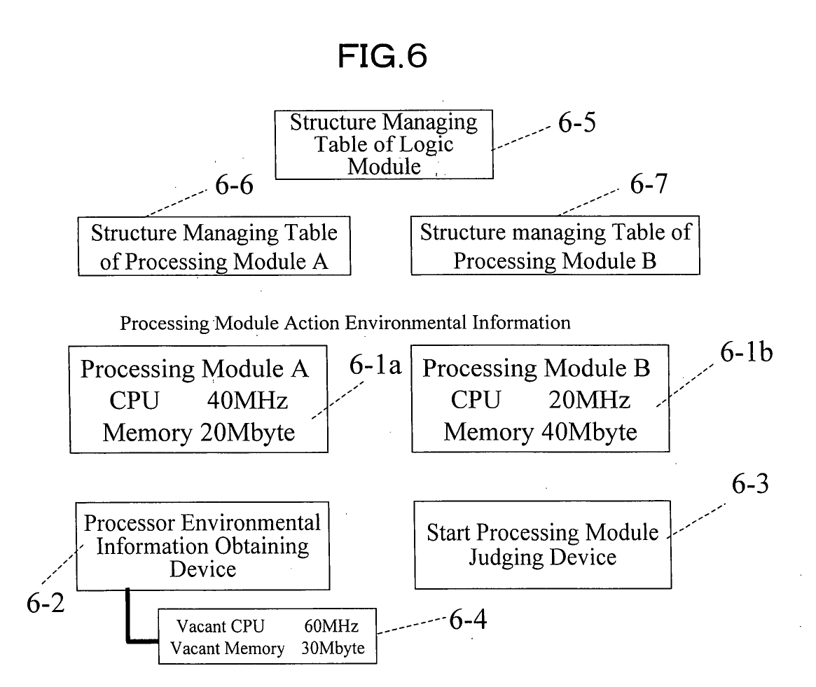

By referring to FIG. 6, the multimedia processing system according to a fourth embodiment of the present invention will be described.

The multimedia processing system as shown in FIG. 6 holds processing module action environmental information such as CPU use amount and memory use amount and the like to be consumed when operating a processing module A (6-1a) and a processing module B (6-1b).

The multimedia processing system comprises: a processor environmental information obtaining device (6-2) which obtains the processor environmental information such as the current CPU use amount and the memory use amount and the like of the processor operated by a processing module A (6-1a) and a processing module B (6-1b); and a start processing module judging device (6-3) which compares the processor environmental information obtained by the processor environmental information obtaining device (6-2) and the processing module action environmental information for judging and starting the optimum multimedia processing module.

FIG. 6 shows the structure of the correspondence managing unit (1-5) of the multimedia processing system. Reference numerals 6-1a and 6-1b represent the processing module action environmental information which indicates use resource of the processing modules of each multimedia. As an example, the frequency of the CPU and the memory used by the processing A (6-1a) and the processing module (6-1b) are illustrated. Reference numeral 6-2 is the processor environmental information obtaining device. For operating the processing modules A (6-1a), B (6-1b) by the own processor, it obtains the information, for example, by calculating the CPU use rate, etc. of the multimedia processing modules A (6-1a), B (6-1b), which are currently operated by the own processor. For operating the processing modules A (6-1a), B (6-1b) by another processor, the information is obtained by making an inquiry to that processor or directly reading the information written on the external memory. In this case, the vacant CPU is 60 MHz and the vacant Memory is 30 MB.

The start processing module judging device (6-3) compares the respective processing module action environmental information of the processing module A (6-1a) and the processing module (6-1b). The processing module A (6-1a) uses a larger amount of CPU but uses less memory compared to the processing module B (6-1b). Thus, when there is a command from the application for giving priority to saving memory or it is decided to give a priority to saving memory in advance, etc., the processing module A (6-1a) is started.

Reference numeral 6-5 represents a structure managing table of the logic module, 6-6 represents a structure managing table of the processing module A, and 6-7 represents a structure managing table of the processing module B.

### Fifth Preferred Embodiment

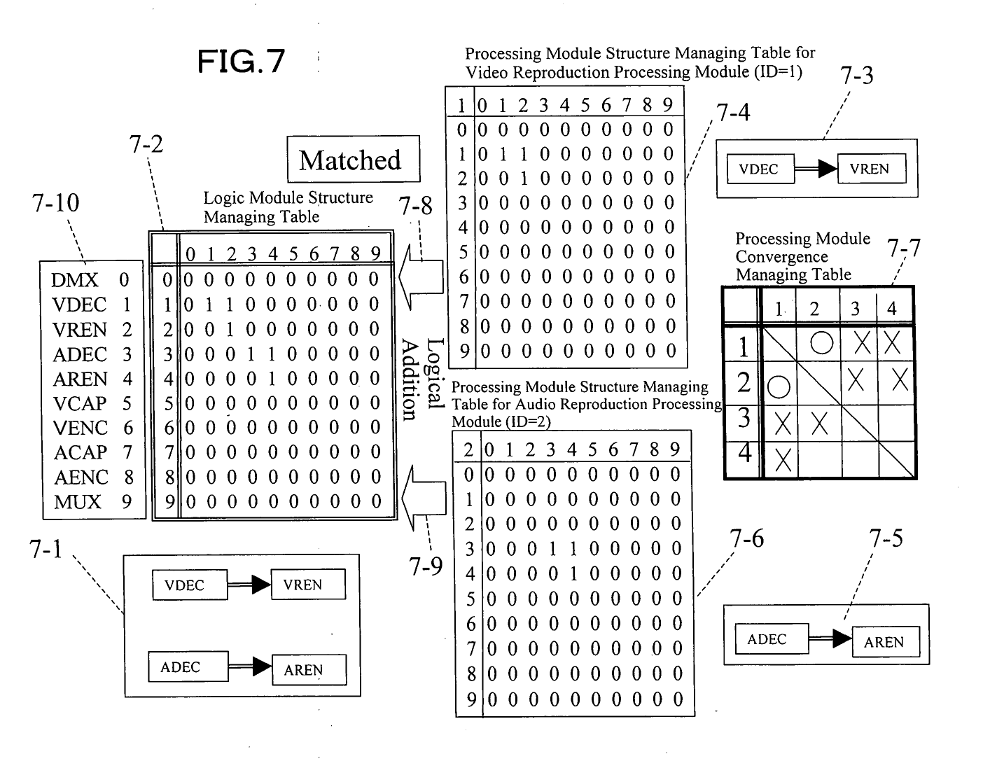

By referring to FIG. 7, the multimedia processing system according to the fifth preferred embodiment of the present invention will be described.

The multimedia processing system of this embodiment investigates the convergence capacities of a plurality of the processing modules and starts each module when there are the ones capable of performing the same processing found in a combination of two or more processing modules at the time of performing matching under the LOCK state.

Specifically, in the multimedia processing system of this embodiment, when the logic modules is connected in the manner as illustrated in 7-1 for performing AV reproduction, the logic module structure managing table becomes the one as illustrated in 7-2. Here, when there are a Video reproduction processing module (7-3) which can perform only Video reproduction and an Audio reproduction processing module (7-5) which can perform only Audio reproduction present in the system, the processing module structure managing tables become the ones shown in 7-4 and 7-6, respectively. In this case, the logic module structure managing table (7-2) is the logical sum the video processing module structure managing table (7-4) and the audio processing module structure managing table (7-6). The logical addition is illustrated by 7-8 and 7-9. By checking a processing module convergence managing table (7-7) which indicates whether or not each processing module can be executed simultaneously, it is found that a video processing module ID=1 and an audio processing module ID=2 can be converged. Therefore, it is judged that both can simultaneously start and perform processing. Thus, the Video reproduction module (7-3) and the Audio reproduction processing module (7-5) are started. Reference numeral 7-10 is an ID managing table of the logic module (7-1).

### Sixth Preferred Embodiment

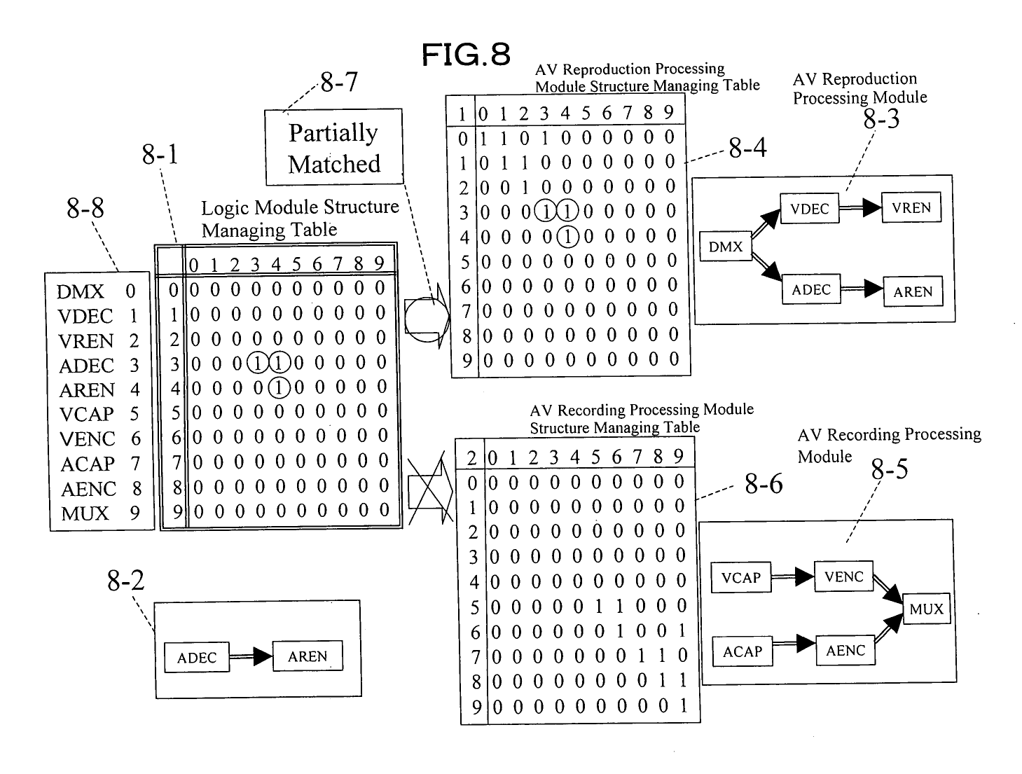

By referring to FIG. 8, the multimedia processing system according to a sixth preferred embodiment of the present invention will be described.

The multimedia processing system of this embodiment, when there is a partially matched processing module found at the time of performing matching under the LOCK state, starts the module for performing only the necessary processing.

Specifically, in the multimedia processing system shown in FIG. 8, when the logic module is connected in the structure as shown in 8-2 for performing the audio reproduction, the logic module structure managing table becomes the one shown in 8-1. Here, when there are an AV reproduction processing module (8-3) and an AV recording processing module (8-5) present in the system, the sections of “1” (sections illustrated by “1” with a circle) in a logic module structure managing table (8-1) are all “1” (sections illustrated by “1” with a circle) in a processing module structure managing table (8-4) of the AV reproduction processing module (8-3), which corresponds to a partial matching (8-7). Thus, in FIG. 8, it is possible to start the AV reproduction-processing module (8-3) and perform reproduction by using only the audio section of the AV reproduction processing module (8-3). Reference numeral 8-6 shows an AV recording processing module structure managing table and 8-8 shows a logic module ID managing table.

### Seventh Preferred Embodiment

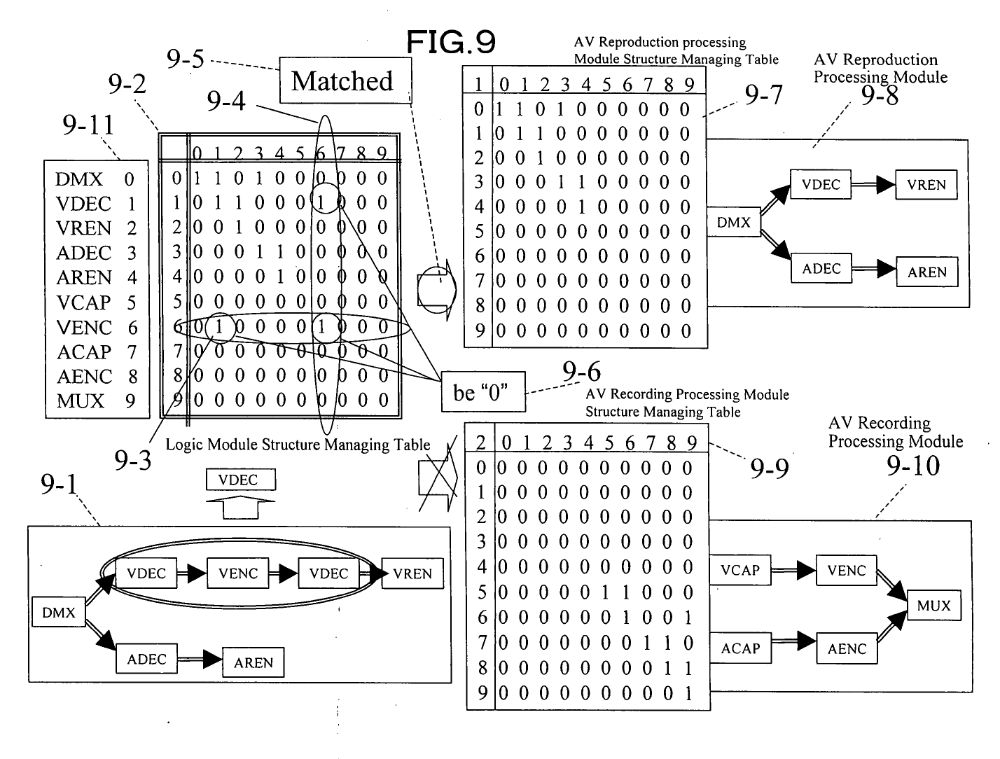

By referring to FIG. 9, the multimedia processing system according to a seventh embodiment of the present invention will be described.

The multimedia processing system of this embodiment, when there is an unnecessary connection found at the time of performing matching under the LOCK state, optimizes the connection and then performs matching of the corresponding processing modules.

Specifically, in the multimedia processing system shown in FIG. 9, when the logic module is connected by the structure as illustrated in 9-1 and the logic module structure managing table is the one as illustrated in 9-2, the unnecessary stream path is found and optimized in the manner described in the followings. When there is a path having only one logic module connected found in a horizontal axis (row) of a logic module structure managing table (9-2) (in the case of FIG. 9, VENC of 9-3 is connected only to VDEC) and if the one connected in the vertical axis (column) of the logic module (VNEC of 9-4 in the case of FIG. 9) is only the above-mentioned logic module (VDEC), the logic module can be eliminated and the row (9-3) and the column (9-4) are all set to be “0”. After performing optimization in the manner as described above, when it matches (9-5) with the processing module structure managing table (9-2) and is optimized in this case, it becomes the same as an AV reproduction processing module structure managing table (9-7). Thus, an AV reproduction processing module (9-8) is started. Reference numeral 9-6 indicates that it becomes “0”. Reference numeral 9-7 shows the AV reproduction processing module structure managing table, 9-8 shows the AV reproduction processing module, 9-9 shows an AV recording processing module structure managing table, 9-10 shows an AV recording processing module, and 9-11 shows a logic module ID managing table.

### Eighth Preferred Embodiment

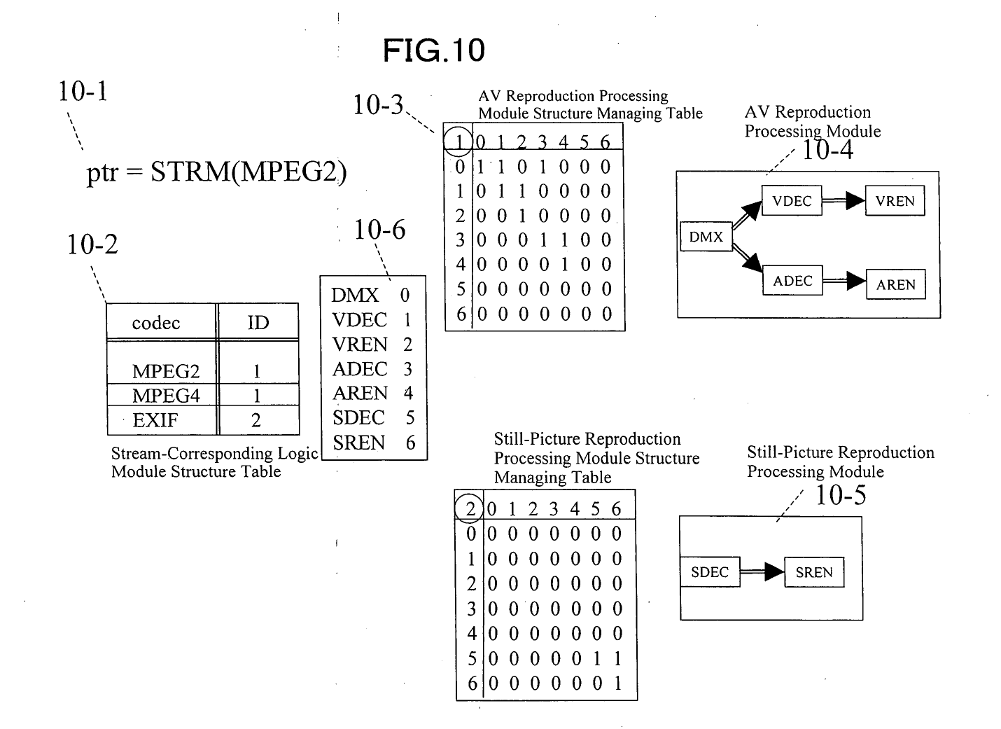

By referring to FIG. 10, the multimedia processing system according to an eighth embodiment of the present invention will be described.

The multimedia processing system of this embodiment has a stream-corresponding logic module structure table which shows the processing module structures necessary for processing each module. By supplying the codec information of only the stream to be flown, the corresponding structure is created based on the stream-corresponding logic module structure table for judging and starting the processing module which is capable of performing the processing.

Specifically, when the application designates the stream to be processed (ptr=STRM (MPEG2)), the multimedia processing system shown in FIG. 10 checks the structure of the corresponding logic module by the stream-corresponding logic module structure table (10-2) which shows the type of stream and the corresponding logic module structure table. In the case of FIG. 10, it can be seen that MPEG2 is ID1, so that the structure is confirmed by a processing module structure managing table (10-3) of ID1. Thereafter, the application transmits a structure confirming command for confirming the corresponding processing module after adding necessary logic module and the like. Reference numeral 10-4 shows an AV reproduction processing module, 10-5 shows a still-picture reproduction processing module, and 10-6 shows a logic module ID managing table.

### Ninth Preferred Embodiment

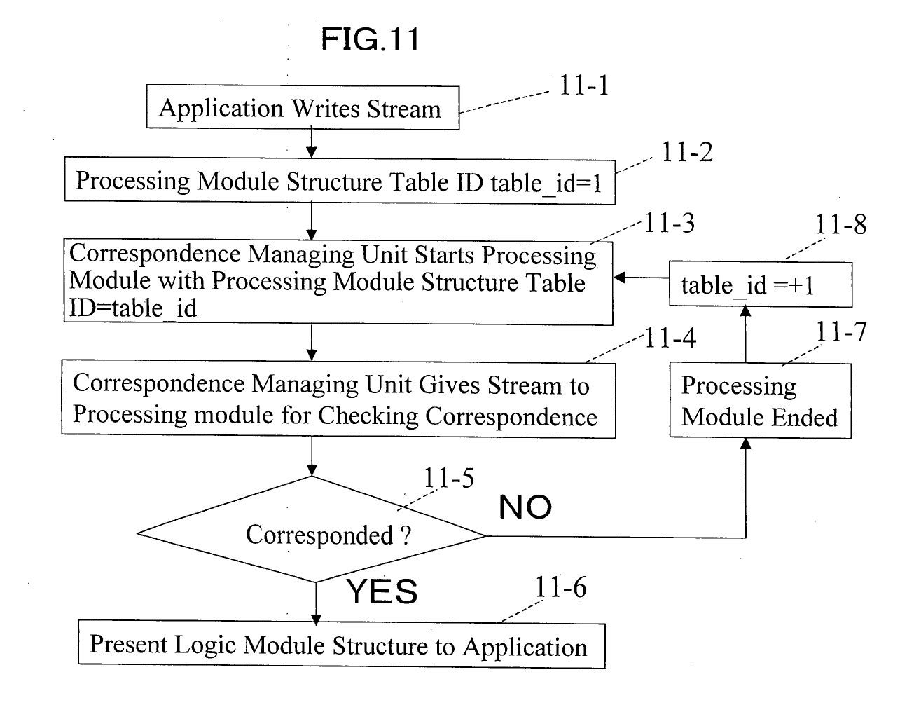

By referring to FIG. 11, the multimedia processing system according to a ninth preferred embodiment of the present invention will be described.

The multimedia processing system of this embodiment has a stream analyzer for analyzing the actually written stream. When a stream is written, the actually written stream is analyzed by the stream analyzer. Thereby, the structure corresponding to the written stream is automatically created for judging and starting the processing module capable of performing the processing.

FIG. 11 shows an operational flow of the stream analyzer of the multimedia processing system. In 11-1, the application (1-7) writes the stream. In 11-2, a variable table_id for showing the processing module structure table ID to be started is set to be “1”. In 11-3, the correspondence managing unit starts the processing module whose processing module structure table ID is table_id. In 11-4, the correspondence managing unit gives the stream to the processing module for inquiring whether or not it is in correspondence. In 11-5, the processing module judges whether or not the stream can be processed. When it is judged “YES” in 11-5 indicating to be processible in 11-5, the structure of the logic module is presented to the application in 11-6. When it is judged “NO” in 11-5 indicating to be not in correspondence, the processing module is ended in 11-7. In 11-8, the operation is repeated again by setting table_id as “+1”.

### Tenth Preferred Embodiment

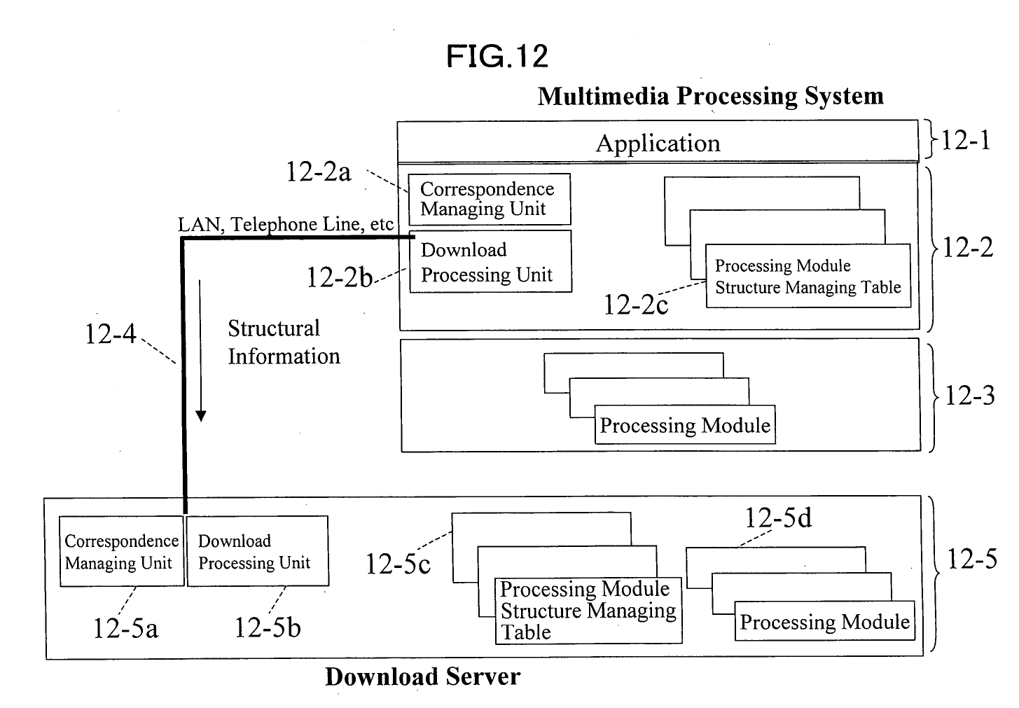

By referring to FIG. 12, the multimedia processing system according to a tenth preferred embodiment of the present invention will be described.

The multimedia processing system of this embodiment, when there is no corresponding processing module found in the system at the time of performing matching under the LOCK state, checks a download server-(12-5) and, if there is any corresponding processing module found, downloads and executes it.

In FIG. 12, reference numeral 12-1 shows an application, 12-2 shows a multimedia processing abstracting unit, and 12-3 shows a multimedia processing module.

A multimedia processing abstracting unit (12-2) comprises a correspondence managing unit (12-2a), a download processing unit (12-2b), and a processing module structure managing table (12-2c).

The download server (12-5) is connected to the multimedia processing abstracting unit (12-2) through a communication line (12-4) such as LAN (including cable and radio network), a telephone line, etc. The download server (12-5) comprises a correspondence managing unit (12-5a), a download processing unit (12-5b), a processing module structure managing table (12-5c), and a processing module (12-5d).

In the multimedia processing system shown in FIG. 12, when there is no corresponding processing module (12-3), the correspondence managing unit (12-2a) makes an inquiry to the download server (12-5) through the communication line (12-4) for checking whether or not there is a corresponding module present. When there is, the corresponding processing module (12-5d) and the processing module structure managing table (12-5c) are downloaded by the download processing unit (12-5b) and started.

### Eleventh Preferred Embodiment

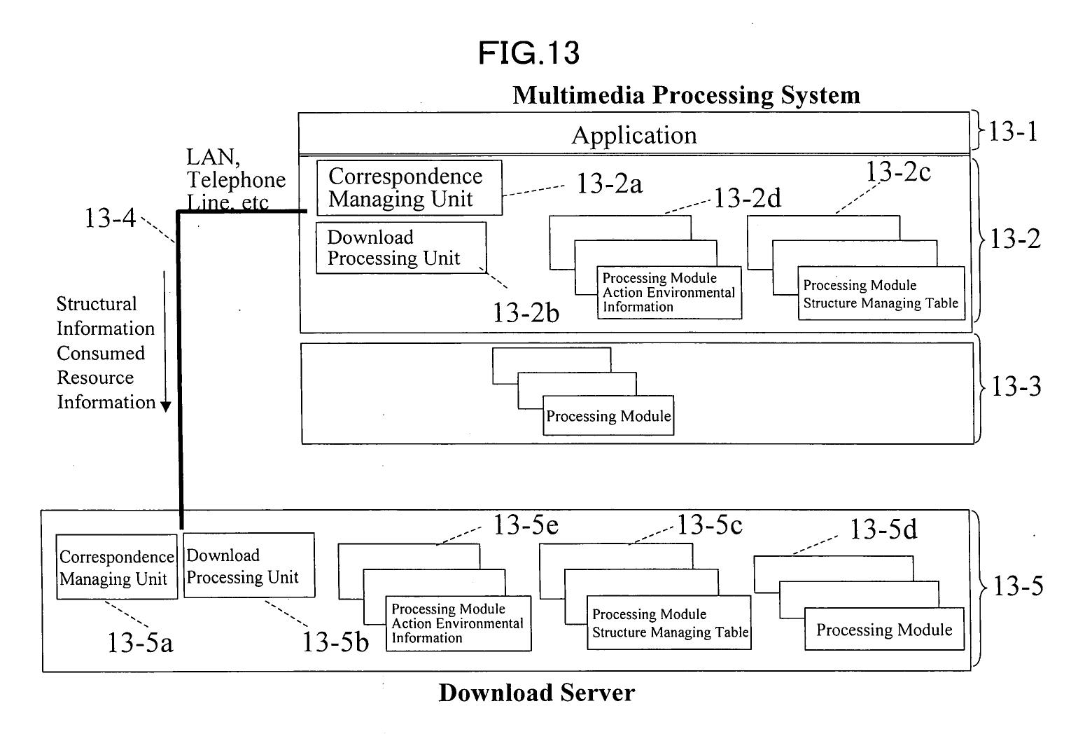

By referring to FIG. 13, the multimedia processing system according to an eleventh preferred embodiment of the present invention will be described.

The multimedia processing system of this embodiment checks the download server even when there is a corresponding module found in the system at the time of performing matching under the LOCK state. When there is another corresponding processing module found, he CPU use amount, the memory use amount and the like are compared. As a result of the comparison, if it is in the better condition than the processing module present in the system, the processing module is downloaded and executed.

In FIG. 13, reference numeral 13-1 shows an application, 13-2 shows a multimedia processing abstracting unit, 13-3 shows a processing module, 13-4 shows a communication line, and 13-5 shows a download server.

The multimedia processing abstracting unit (13-2) comprises a correspondence managing unit (13-2a), a download processing unit (13-2b), a processing module structure managing table (13-2c) and processing module action environmental information (13-2d).

The download server (13-5) is connected to the multimedia processing abstracting unit (13-2) through the communication line (13-4). The download server (13-5) comprises a correspondence managing unit (13-5a), a download processing unit (13-5b), a processing module structure managing table (13-5c), a processing module (13-5d), and processing module action environmental information (13-5e).

In the multimedia processing system shown in FIG. 13, there is also provided in the download server the processing module action environmental information (13-5e) as of 6-1a, 6-1b shown in FIG. 6. Even when there is a corresponding processing module found in the multimedia processing system at the time of performing matching, it is compared with the corresponding processing module action environmental information (13-5e) by inquiring to the download server. If the processing module obtained through the download server is in the better condition, (e.g., the resource to be used is smaller with the processing module of the download server), the processing module is downloaded and executed.

### Twelfth Preferred Embodiment

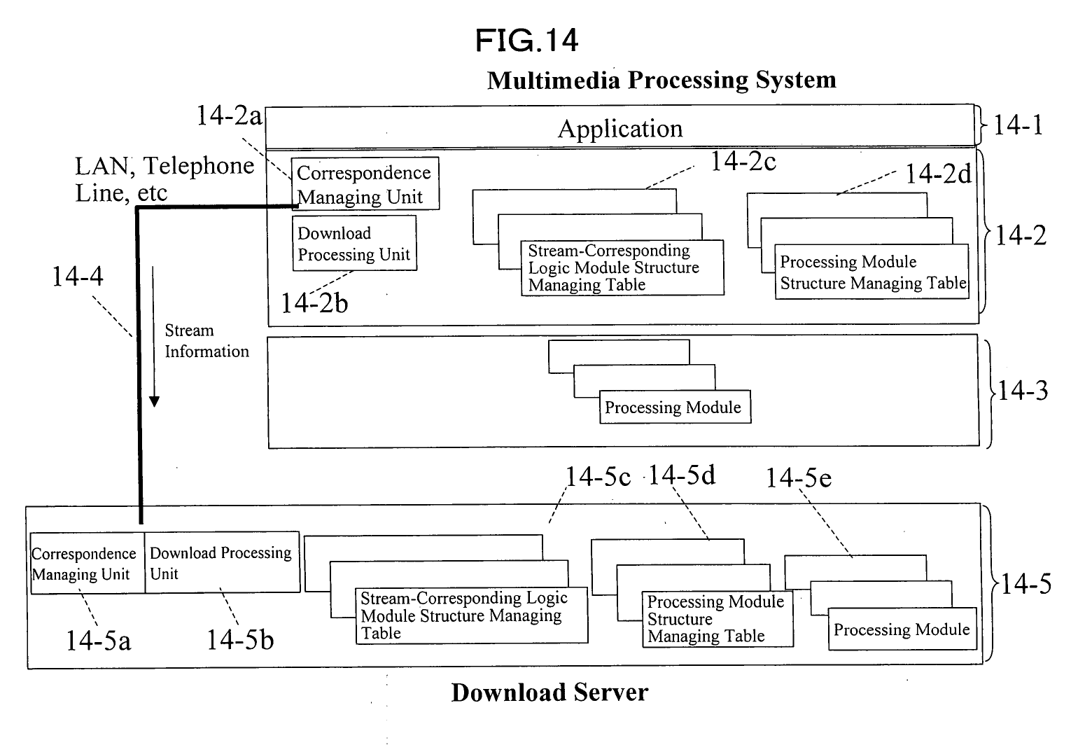

By referring to FIG. 14, the multimedia processing system according to a twelfth embodiment of the present invention will be described.

In the multimedia processing system of this embodiment, a download server (14-5) also has a stream-corresponding logic module structure managing table (14-5c). When there is no corresponding stream-corresponding logic module structure managing table (14-2c) in the multimedia processing system, stream information is transmitted to the download server (14-5) for searching the stream-corresponding logic module structure managing table (14-5c) within the download server (14-5). If there is any matching, the matched one is downloaded.

Reference numeral 14-1 shows an application, 14-2 shows a multimedia processing abstracting unit, 14-3 shows a processing module, 14-4 shows a communication line, and 14-5 shows the download server.

The multimedia processing abstracting unit (14-2) comprises a correspondence managing unit (14-2a), a download processing unit (14-2b), a stream-corresponding logic module structure managing table 14-2c, and a processing module structure managing table (14-2d).

The download server (14-5) is connected to the multimedia processing abstracting unit (14-2) through the communication line (14-4). The download server (14-5) comprises a correspondence managing unit (14-5a), a download processing unit (14-5b), a stream-corresponding logic module structure managing table (14-5c), a processing module structure managing table (14-5d), and a processing module (14-5e).

In FIG. 14, when there is no corresponding stream-corresponding logic module structure managing table (14-2c) present in the multimedia processing abstracting unit (14-2), the correspondence managing unit (14-2a) makes an inquiry to the correspondence managing server (14-5a) of the download server (14-5) through the communication line (14-4) for checking whether or not there is a corresponding stream-corresponding logic module structure managing table (14-5c) present. When there is, the corresponding stream-corresponding logic module structure managing table (14-5c) is downloaded by the download processing unit (14-5b) and started.

### Thirteenth Preferred Embodiment

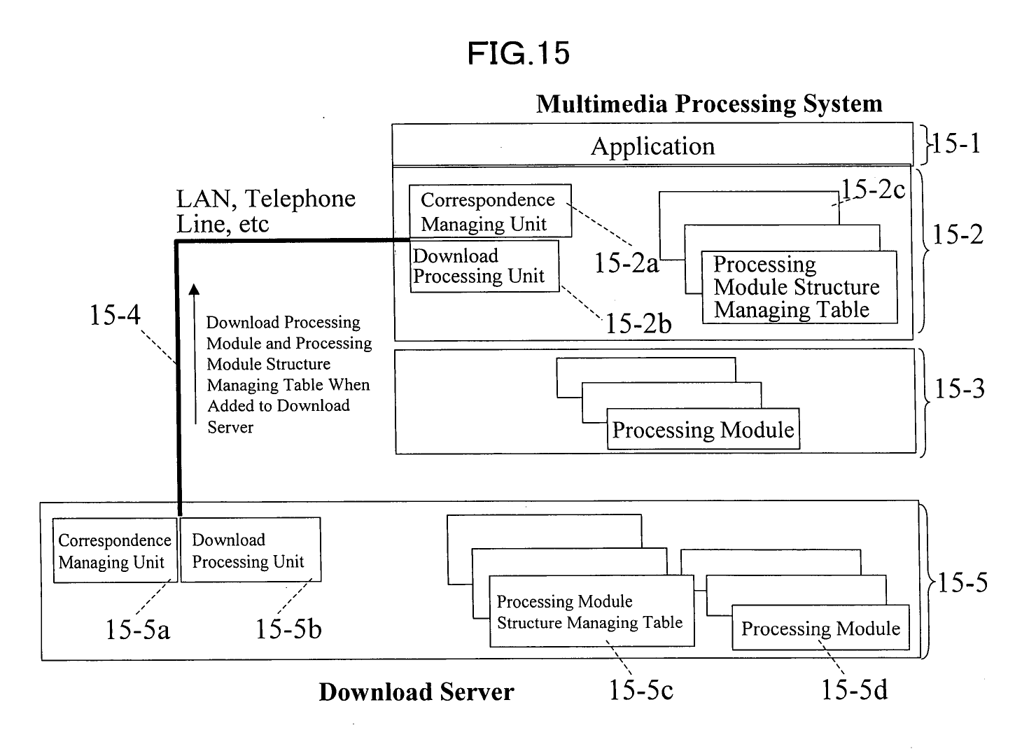

By referring to FIG. 15, the multimedia processing system according to a thirteenth embodiment of the present invention will be described.

In the multimedia processing system of this embodiment, at the point where a processing module (15-5d) and a processing module structure managing table (15-5c) are added to a download server (15-5), the multimedia processing system downloads the processing module (15-5d) and the processing module structure managing table (15-5c). With this, it is possible to always carry a new processing module (15-3) so that overhead can be reduced by downloading the module in advance to be ready when it becomes necessary compared to the case where the module is downloaded and obtained when there is none found in the terminal of the multimedia processing system.

In FIG. 15, reference numeral 15-1 shows an application, 15-2 shows a multimedia processing abstracting unit, 15-3 shows the processing module, 15-4 shows a communication line, and 15-5 shows the download server.

The multimedia processing abstracting unit (15-2) comprises a correspondence managing unit (15-2a), a download processing unit (15-2b), and a processing module structure managing table (15-2c).

The download server (15-5) is connected to the multimedia processing abstracting unit (15-2) through the communication line (15-4). The download server (15-1) comprises a correspondence managing unit (15-5a), a download processing unit (15-5b), a processing module structure managing table (15-5c), and a processing module (15-5d).

### Fourteenth Preferred Embodiment

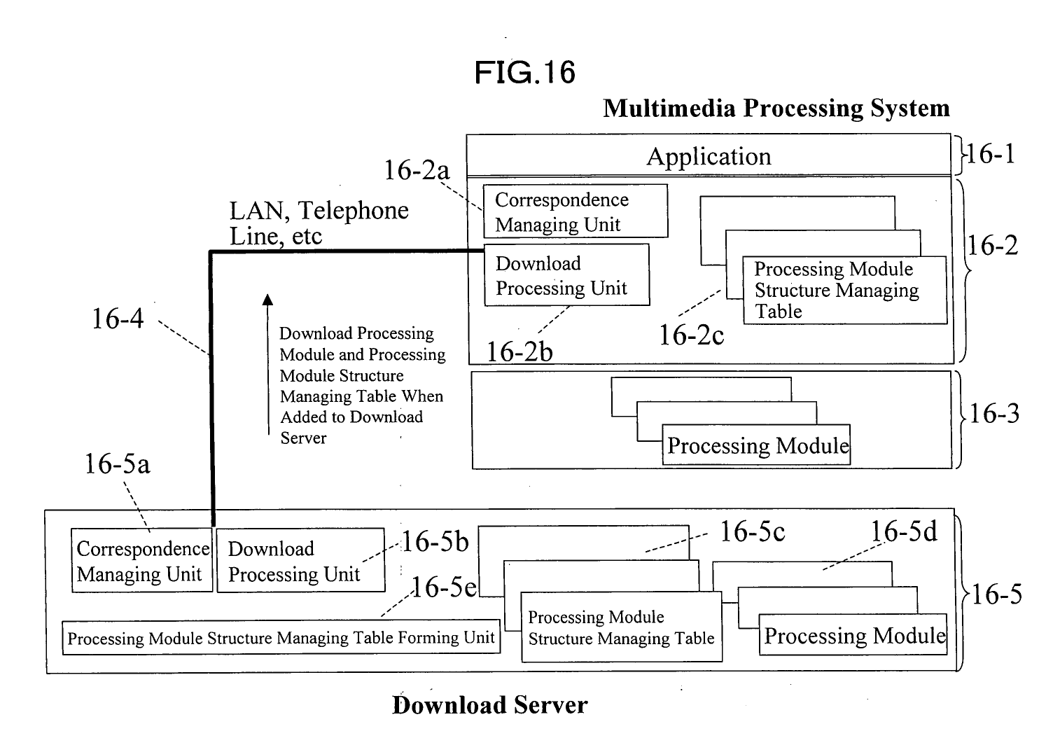

By referring to FIG. 16, the multimedia processing system according to a fourteenth preferred embodiment of the present invention will be described.

When a new processing module (16-5d) is added to a download server (16-5), the multimedia processing system of this embodiment executes a processing module structure managing table forming unit (16-5e) which investigates the structure of the processing module (16-5d) within the download server (16-5) With this, a processing module structure managing table (16-5c) is formed and downloaded.

In FIG. 16, numeral reference 16-1 shows an application, 16-2 shows a multimedia processing abstracting unit, 16-3 shows a processing module, 16-4 shows a communication line, and 16-5 shows the download server.

The multimedia processing abstracting unit (16-2) comprises a correspondence managing unit (16-2a), a download processing unit (16-2b), and a processing module structure managing table (16-2c).

The download server (16-5) is connected to the multimedia processing abstracting unit (16-2) through the communication line (16-4). The download server (16-5) comprises a correspondence managing unit (16-5a), a download processing unit (16-5b), a processing module structure managing table (16-5c), the processing module (16-5d) and the processing module structure managing table forming unit (16-5e).

The multimedia processing system shown in FIG. 16 executes the processing module (16-5d) at the point where the processing module (16-5d) is added to the download server (16-5). The processing module structure managing table forming unit (16-5e) within the download server (16-5) inquires and investigates the mounting state of each function and forms the processing module structure managing table (16-5c).

### Fifteenth Preferred Embodiment

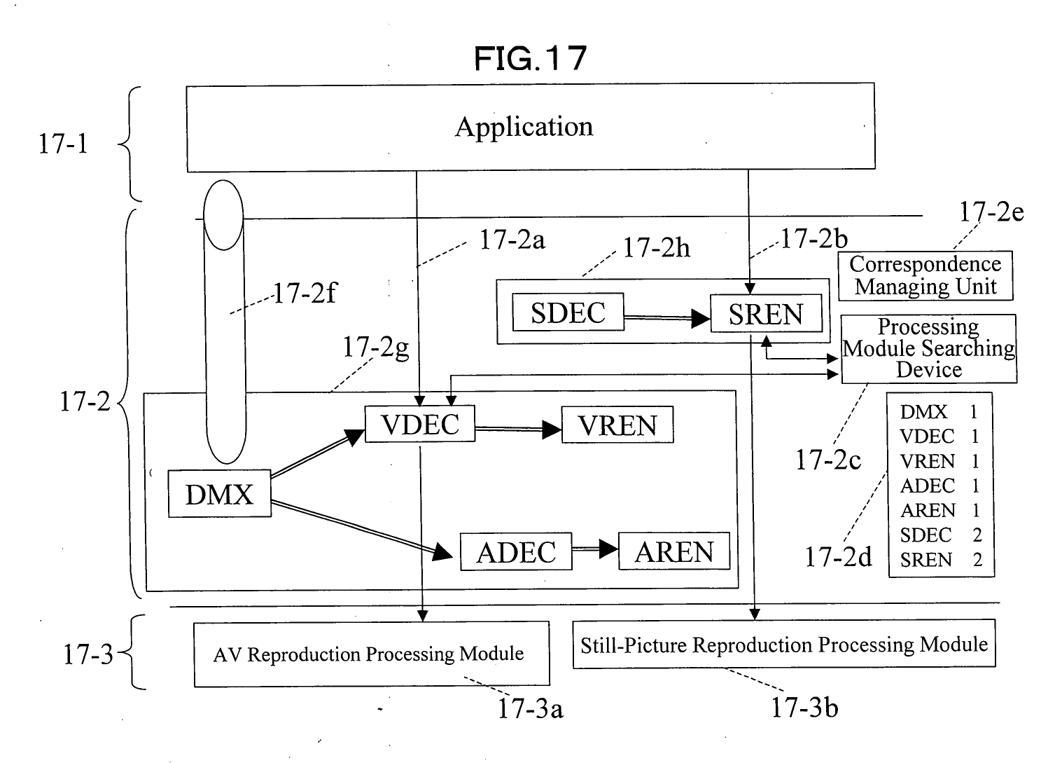

By referring to FIG. 17, the multimedia processing system according to a fifteenth preferred embodiment of the present invention will be described.

The multimedia processing system of this embodiment, after creating the processing module, searches the corresponding processing module and transmits a control command to the processing module obtained by the search when an application transmits the control command to each logic module.

In FIG. 17, reference numeral 17-1 shows the application, 17-2 shows a multimedia processing abstracting unit, and 17-3 shows the multimedia processing module.

In the multimedia processing abstracting unit 17-2, reference numerals 17-2a and 17-2b show a command transmission from the application (17-1), 17-2c shows a processing module searching device, 17-2d shows a logic-module-corresponding processing module table which holds the relation between the logic module and the corresponding processing module ID, 17-2e shows a correspondence managing unit, 17-2f shows a stream pipe, 17-2g shows an AV reproduction logic module, and 17-h shows a still-picture reproduction logic module.

The multimedia processing module (17-3) comprises an AV reproduction processing module (17-3a) and a still-picture reproduction processing module (17-3b).

The multimedia processing system of this embodiment comprises the processing module searching device (17-2c) which, after the corresponding processing module is started and commands (17-2a) and (17-2b) are transmitted to each of the logic modules (17-2g), (17-2h), searches to determine which of the processing modules (17-3a), (17-3b) the commands (17-2a), (17-2b) are to be transmitted to for performing transmission.

Specifically, in the multimedia processing system of this embodiment, when the application (17-1) issues the commands (17-2a), (17-2b) to the logic modules (17-2g), (17-2h), an inquiry is made to the processing module searching device (17-2c). The processing module searching device (17-2c) searches the logic-module-corresponding processing module table (17-2d) which shows the correspondence relation between the logic modules (17-2g), (17-2h) and the processing modules (17-3a), (17-3b) for finding the corresponding processing modules (17-3a), (17-3b) to notify the logic module. The logic modules (17-2g), (17-2h) perform control over the corresponding processing modules (17-3a), (17-3b).

### Sixteenth Preferred Embodiment

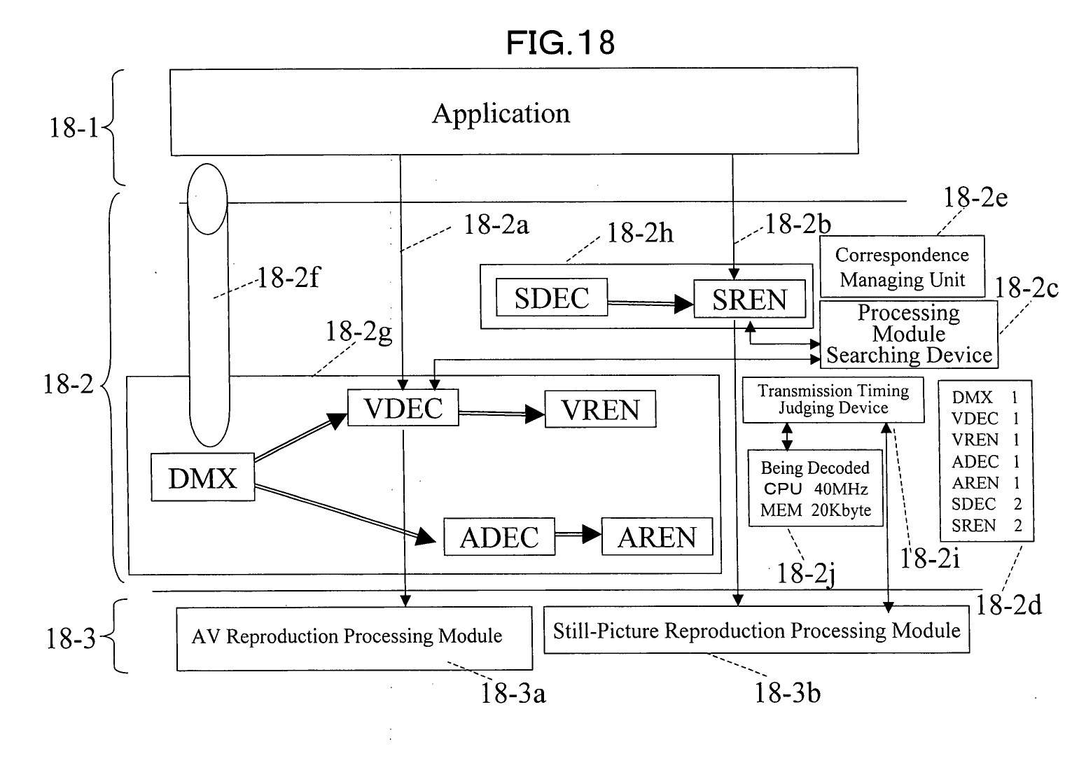

By referring to FIG. 18, the multimedia processing system according to a sixteenth preferred embodiment of the present invention will be described.

The multimedia processing system of this embodiment, after processing modules are created and an application transmits a control command to each processing module, searches the corresponding processing module. When transmitting the control command to the processing module obtained by the search, the control command is transmitted at an appropriate timing.

In FIG. 18, reference numeral 18-1 shows the application, 18-2 shows a multimedia processing abstracting unit, and 18-3 shows a multimedia processing module.

In the multimedia processing abstracting unit 18-2, reference numerals 18-2a, 18-2b show the command transmission from the application (18-1), 18-2c shows a processing module searching device, 18-2d shows a logic-module-corresponding processing module table which holds the relation between the logic module and the corresponding processing module ID, 18-2e shows a correspondence managing unit, 18-2f shows a stream pipe, 18-2g shows an AV reproduction logic module, and 18-2h shows a still-picture reproduction logic module. 18-2i shows a transmission timing judging device and 18-2j shows a processing-module-state holding device.

The multimedia processing module (18-3) comprises an AV reproduction processing module (18-3a) and a still-picture reproduction processing module (18-2b).

The multimedia processing system of this embodiment, after starting the corresponding processing module and transmitting the commands (18-2a), (18-2b) to each of the logic modules (18-3a), (18-3b), searches the processing modules (18-3a), (18-3b) by the processing module searching device (18-2c). Then, based on the held information (18-2j) on the processing module or by inquiring to the processing module, an appropriate timing for transmission is judged by the transmission timing judging device (18-2i) and transmission is performed.

Specifically, in the multimedia processing system shown in FIG. 18, after determining the corresponding processing module by the processing module searching device (18-2c), the transmission timing judging device (18-2i) makes an inquiry to the processing-module-state holding device (18-2j) or the processing module, and issues a command at an appropriate timing such as when the processing amount is small, etc.

### Seventeenth Preferred Embodiment

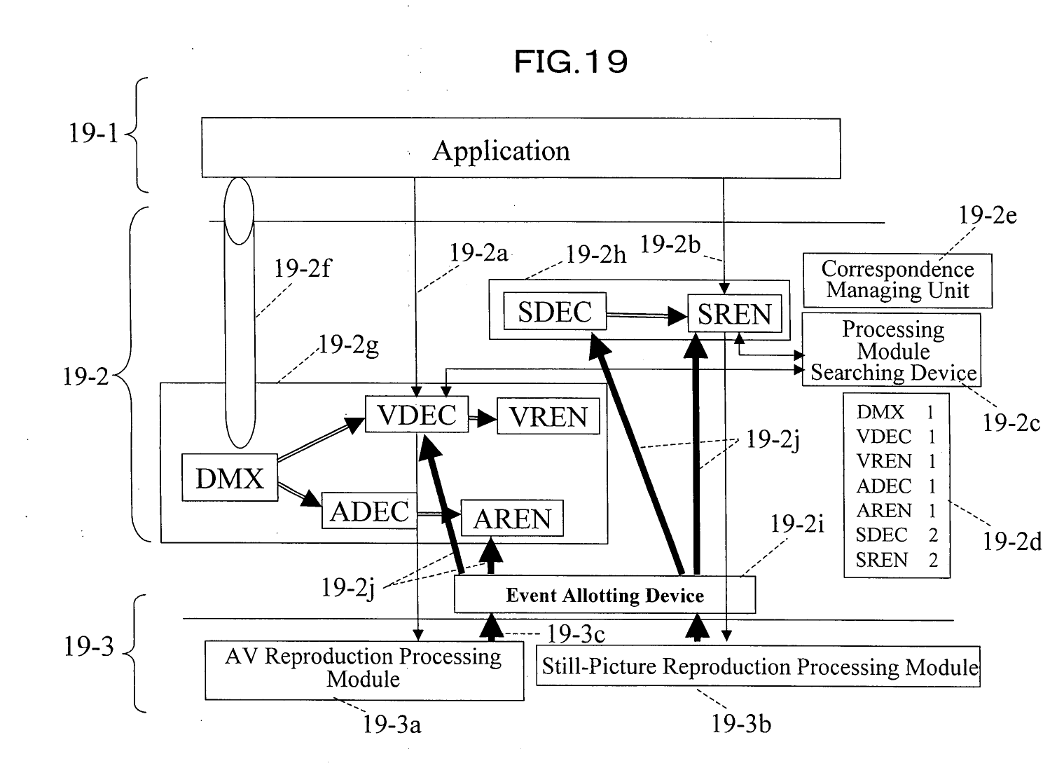

By referring to FIG. 19, the multimedia processing system according to a seventeenth embodiment of the present invention will be described.

The multimedia processing system of this embodiment, after the corresponding processing module is started and an event is up from the processing module, allots the event to an appropriate logic module.

In FIG. 19, reference numeral 19-1 shows an application, 19-2 shows a multimedia processing abstracting unit, and 19-3 shows a multimedia processing module.

In the multimedia processing abstracting unit 19-2, reference numerals 19-2a, 19-2b show the command transmission from the application (19-1), 19-2c shows a processing module searching device, 19-2d shows a logic-module-corresponding processing module table which holds the relation between the logic module and the corresponding processing module ID, 19-2e shows a correspondence managing unit, 19-2f shows a stream pipe, 19-2g shows an AV reproduction logic module, 19-2h shows a still-picture reproduction logic module, and 19-2i shows an event allotting device.

The multimedia processing module (19-3) comprises an AV reproduction processing module (19-3a) and a still-picture reproduction processing module (19-3b).

The multimedia processing system of this embodiment comprises the event allotting device (19-2i) for judging which of the logic modules the event is directed to according to the structural information, after the corresponding processing module is started and there is the event (19-3c) created from the corresponding processing module.

Specifically, in the multimedia processing system shown in FIG. 19, when there is an event created from the Av reproduction processing module (19-3a) or the still-picture reproduction processing module (19-3b), the event allotting device (19-2i) receives the event. The event allotting device (19-2i) judges which one of the logic modules (19-2g) and (19-2h) the event should be allotted to based on the contents of the event (19-3c). As a result of the judgment, the event (19-2i) is informed to one of the logic modules (19-2g), (19-2h) as the target for allotting the event.

### Example of Applicable Apparatus

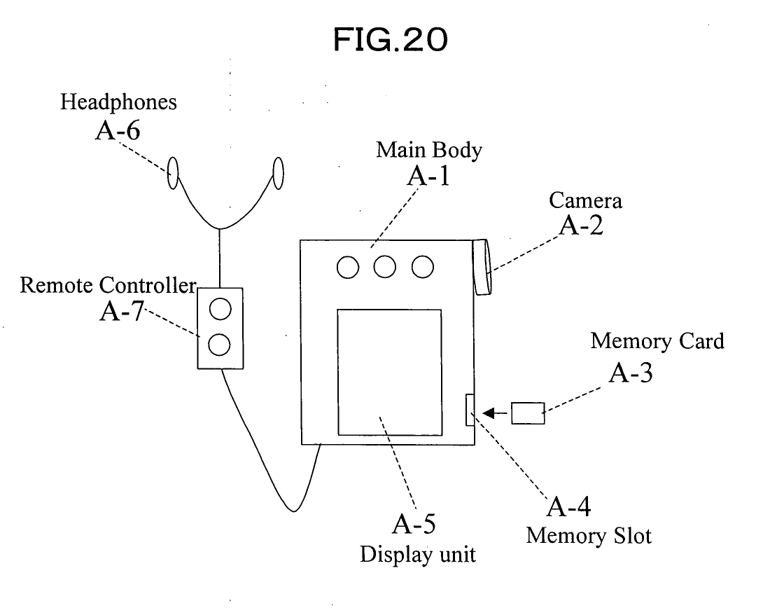

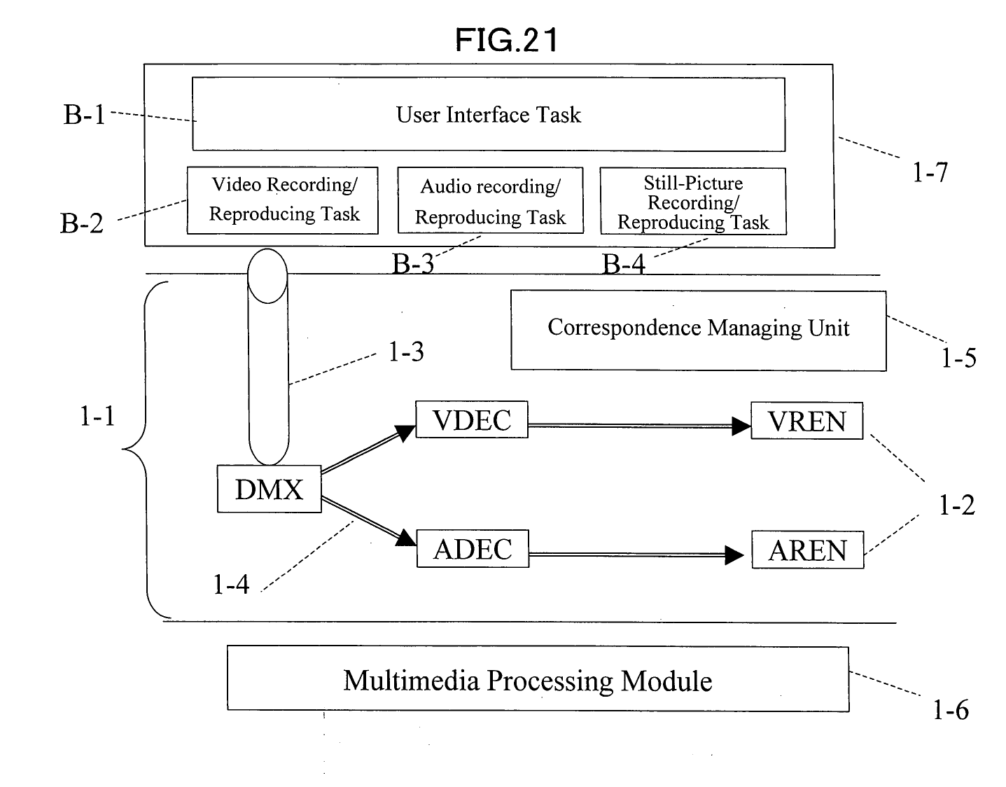

By referring to FIG. 20 and FIG. 21, described is an example of an apparatus to which the present invention is applied. FIG. 20 shows the structure of the apparatus to which the present invention is applied. Reference numeral A-1 is an apparatus main body, A-2 is a camera, A-3 is a memory card to which data of music, moving pictures, etc. are recorded, A-4 is a memory slot to which the memory card A-3 is inserted, A-5 is a liquid crystal display unit for viewing images and moving picture data, A-6 is a pair of headphones, and A-7 is a remote controller for giving a command such as reproduction and the like.

As shown in FIG. 21, an application (1-7) of the apparatus shown in FIG. 20 is comprised of a user interface task B-1, a video recording/reproducing task B-2, an audio recording/reproducing task B-3, and a still-picture recording/reproducing task B-4.

Upon receiving a command for changing to a mode requested by a user through the remote controller A-7 or the like, the user interface task B-1 transmits the command to the video recording/reproducing task B-2 for switching to the mode for filming videos, to the audio recording/reproducing task B-3 for switching to the mode for listening to audios, and to the still-picture recording/reproducing task B-4 for switching to the mode for picking up still pictures. Each task gives a command to a multimedia processing abstracting unit (1-1) to create and connect a necessary logic module (1-2). By issuing a LOCK command, an actual multimedia processing module (1-6) is created. Then, by pressing a reproduction button in the remote controller A-7, the user interface task B-1 transmits the command to the tasks B-2, B-3, and B-4 for the current mode. Each of the tasks B-2, B-3, and B-4 gives a command to the multimedia processing abstracting unit (1-1).

While the invention has been described and illustrated in detail, it is to be clearly understood that this is intended be way of illustration and example only and is not to be taken by way of limitation, the spirit and scope of this invention being limited only be the terms of the following claims.

What is claimed is:

1. A multimedia processing system, comprising
an application for giving a command to create and connect a logic module and for informing structure confirmation of said logic module,
a multimedia processing abstracting unit which works according to said command from said application, and
a processing module for performing actual multimedia processing, wherein
said multimedia processing abstracting unit is comprised of:
a logic module for abstracting each function for said multimedia processing;
a stream path for connecting said each logic module;
a stream pipe for transmitting/receiving data between said each logic module and said application; and
a correspondence managing unit which carries structural information of said logic module, said stream pipe, and said stream path for making correspondence with said processing module, wherein
said correspondence managing unit updates said structural information every time said each logic module is created and connected according to said command from said application and, thereafter, at a point where said stream pipe and stream path are connected, receives a LOCK command indicating confirmation of structure from said application, said correspondence managing unit thereby confirming and starting one corresponding processing module.

2. The multimedia processing system according to claim 1, wherein:
in an arbitrary logic module, said multimedia processing abstracting unit receives said LOCK command indicating confirmation of structure of said logic module from said application at a point where connection of said stream pipe and said stream path is completed, and confirms and starts a corresponding logic module at a point where all logic modules reachable from said logic module through said stream path have received said LOCK command.

3. The multimedia processing system according to claim 1, wherein:
for forming said processing module by creating and connecting said logic module from a plurality of application tasks, information indicating which of said application tasks gives a LOCK command to said logic module is held in a table in advance for checking which of said application tasks has called said LOCK command when there is said LOCK command from said application; and when there is no corresponding processing module found at a point where all LOCKs from a single application task are completed, said application task is switched so that following processing is not performed until a corresponding processing module is started.

4. The multimedia processing system according to claim 1, comprising:
a processor environmental information obtaining means which holds processing module action environmental information such as CPU use amount and memory use amount to be consumed when operating each said processing module and obtains processor environmental information such as current CPU use amount and memory use amount of a processor operated by said processing module; and a processing module judging means which judges and starts an optimum multimedia processing module by comparing said processor environmental information obtained by said processor environmental information obtaining means and said processing module action environmental information.

5. The multimedia processing system according to claim 1, wherein
at a time of performing matching under a LOCK state, when there are processing modules capable of same processing in a combination of two or more processing modules, convergence capacities of a plurality of said processing modules are investigated, respectively, to be started.

6. The multimedia processing system according to claim 1, wherein
at a time of performing matching under a LOCK state, when there is processing module which is partially in match, said module is started for performing only necessary processing.

7. The multimedia processing system according to claim 1, wherein
at a time of performing matching under a LOCK state, when there is unnecessary connection, matching of corresponding processing module is performed after optimizing said connection.

8. The multimedia processing system according to claim 1, comprising a stream-corresponding logic module structure table which shows logic module structures necessary for processing each stream, wherein
by giving only codec information of a stream to be flown, a corresponding structure is created based on said stream-corresponding logic module structure table for judging and starting a processing module which can perform processing.

9. The multimedia processing system according to claim 1, comprising a stream analyzing means for analyzing an actually written stream, wherein
through analyzing said actually written stream using said stream analyzing means by simply writing a stream, a corresponding structure for said written stream is automatically created for judging and starting a processing module which can perform processing.

10. The multimedia processing system according to claim 1, wherein
at a time of performing matching under a LOCK state, when there is no corresponding processing module in said system, a download server is checked and when there is a corresponding processing module found therein, said corresponding processing module is downloaded and executed.

11. The multimedia processing system according to claim 1, wherein
at a time of performing matching under a LOCK state, even when there is a corresponding processing module in said system, a download server is checked, and when there is another corresponding processing module found therein and it is judged that said another module is in a better condition than said existing module by comparing them to CPU use amount and memory use amount and the like, said another corresponding processing module is downloaded and executed.

12. The multimedia processing system according to claim 8, wherein
when there is no corresponding processing module, said codec information is transmitted to a download server and a corresponding structure is checked within said download server for downloading a processing module and a structure table.

13. The multimedia processing system according to claim 1, wherein
in a case where a new processing module and a processing module structure managing table are added to a download server, said new processing module can be added by downloading said processing module and structural information.

14. The multimedia processing system according to claim 1, wherein
in a case where a new processing module is added to a download server, a processing module structure managing table is created and downloaded by executing a structure checking unit which checks structure of said processing module within said download server.

15. The multimedia processing system according to claim 1, comprising a processing module searching means for searching which processing module is a target of transmitting a command and transmitting said command thereto when said command is transmitted to each logic module after starting a corresponding processing module.

16. The multimedia processing system according to claim 15, comprising a transmission timing judging means which judges an appropriate timing for transmission and performs transmission based on processing module information being held or by inquiring to a processing module after searching corresponding processing module by said processing module searching means when said command is transmitted to each logic module after starting a corresponding processing module.

17. The multimedia processing system according to claim 1, comprising an event allotting means for judging based on structural information which logic module an event is directed to when there is said event up from a corresponding processing module after starting said corresponding processing module.
